(19) United States
(12) Patent Application Publication
(10) Pub. No.: US 2015/0266247 A1
(43) Pub. Date: Sep. 24, 2015

(54) METHOD OF RESTORING THE TRANSPARENCY OF PLASTIC LENSES

(71) Applicant: Chris Duane BINGHAM, Graham, KY (US)

(72) Inventor: Chris Duane BINGHAM, Graham, KY (US)

(21) Appl. No.: 14/662,020

(22) Filed: Mar. 18, 2015

Related U.S. Application Data
(60) Provisional application No. 61/954,959, filed on Mar. 18, 2014.

(51) Int. Cl. B29C 73/26; B05D 3/00

(52) U.S. Cl. CPC B29C 73/26; B05D 3/002; B29C 2073/262; B29L 2031/30

(57) ABSTRACT

A method for inexpensively cleaning plastic headlight lenses of a vehicle, whereby transparency is restored along with driver safety and visibility is provided. The method may remove oxidation and other indicia of opacity from the lens by a sequence of varying wet sanding applications. Following the wet sanding, the method may include the application of polish and sealant so as to obtain a high gloss finish.

### CROSS-REFERENCE TO RELATED APPLICATION

This application claims the benefit of priority of U.S. provisional application No. 61/954,959, filed 18 Mar. 2014, the contents of which are herein incorporated by reference.

### BACKGROUND OF THE INVENTION

The present invention relates to methods of restoring the transparency of plastic and, more particularly, a method for inexpensively cleaning plastic headlights lens.

When cleaning and restoring a vehicle's plastic headlight lens, removing oxidation and/or scratches is vital to increasing visibility and thus safety for a driver of the vehicle. Current methods are only one or two steps that only appear to clean the plastic lens; however, such methods leave the lens' condition of transparency compromised, jeopardizing the efficacy of the headlights and the driver's safety.

Currently, the safest practice is to completely replace the plastic headlights lens when the lens' transparency is compromised, resulting in frequent, steep replacement costs.

As can be seen, there is a need for a method for inexpensively cleaning plastic headlights lens without the need for replacement, whereby transparency is restored along with driver safety and visibility.

### SUMMARY OF THE INVENTION

In one aspect of the present invention, a method of increasing the transparency of plastic lens by removing the indicia of opacity includes applying water to the plastic lens; providing a second stage coated abrasive; wet sanding the second stage coated abrasive to the water-applied plastic lens until oxidation defects and scratches amounting to indicia of opacity are removed; reapplying water to the plastic lens; providing a third stage coated abrasive; and wet sanding the third stage coated abrasive to the water-reapplied plastic lens until oxidation defects, scratches and roughness amounting to indicia of opacity are removed.

In another aspect of the present invention, method of increasing the transparency of plastic lens by removing the indicia of opacity includes applying water to the plastic lens; providing a first stage coated abrasive, wherein the first stage coated abrasive has a grit size ranging from approximately 220 to 800; wet sanding the first stage coated abrasive to the water-applied plastic lens until oxidation defects amounting to indicia of opacity are removed; reapplying water to the plastic lens; providing a second stage coated abrasive, wherein the second stage coated abrasive has a grit size ranging from approximately 800 to 1500; wet sanding the second stage coated abrasive to the water-reapplied plastic lens until oxidation defects and scratches amounting to indicia of opacity are removed; reapplying water to the plastic lens; providing a third stage coated abrasive, wherein the third stage coated abrasive has a grit size ranging from approximately 1500 to 3500; and wet sanding the third stage coated abrasive to the water-reapplied plastic lens until oxidation defects, scratches and roughness amounting to indicia of opacity are removed, wherein wet sanding is performed with a horizontal motion across the plastic lens.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a vehicle with dirty headlights;

FIG. 2 is an exploded view of an exemplary embodiment of various stages of the present invention;

FIG. 3 is an exploded view of an exemplary embodiment of a polishing compound and a sealant of the present invention;

FIG. 4 is a perspective view of an exemplary embodiment of a useful high gloss finish resulting from the present invention;

FIG. 5 is a flow chart of an exemplary embodiments of an arrangement of steps of the present invention; and

FIG. 6 is a continuation of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for inexpensively cleaning plastic headlight lenses of a vehicle, whereby transparency is restored along with driver safety and visibility. Specifically, the method removes oxidation and other indicia of opacity from the lens by a sequence of varying wet sanding applications. Following the wet sanding, the method may include the application of polish and sealant so as to obtain a high gloss finish.

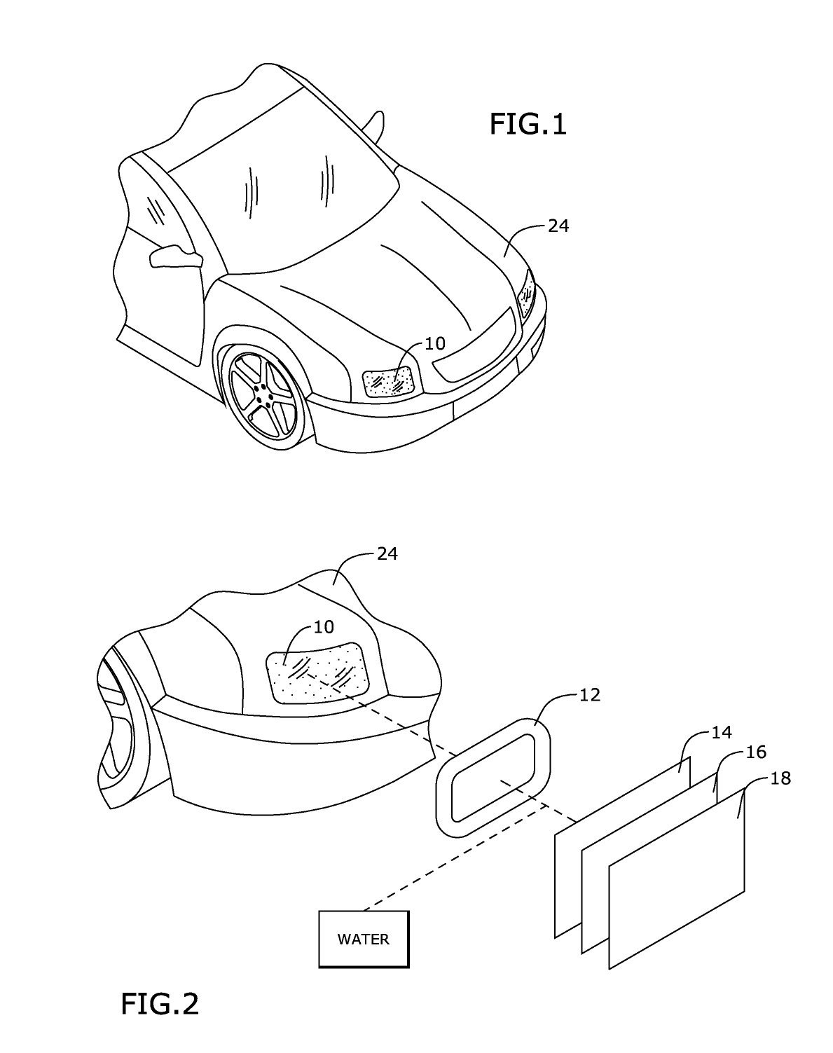

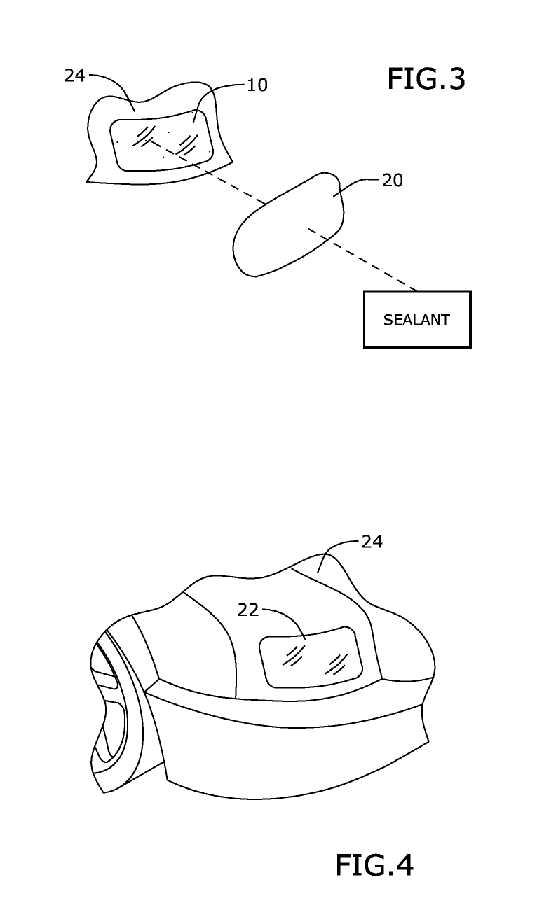

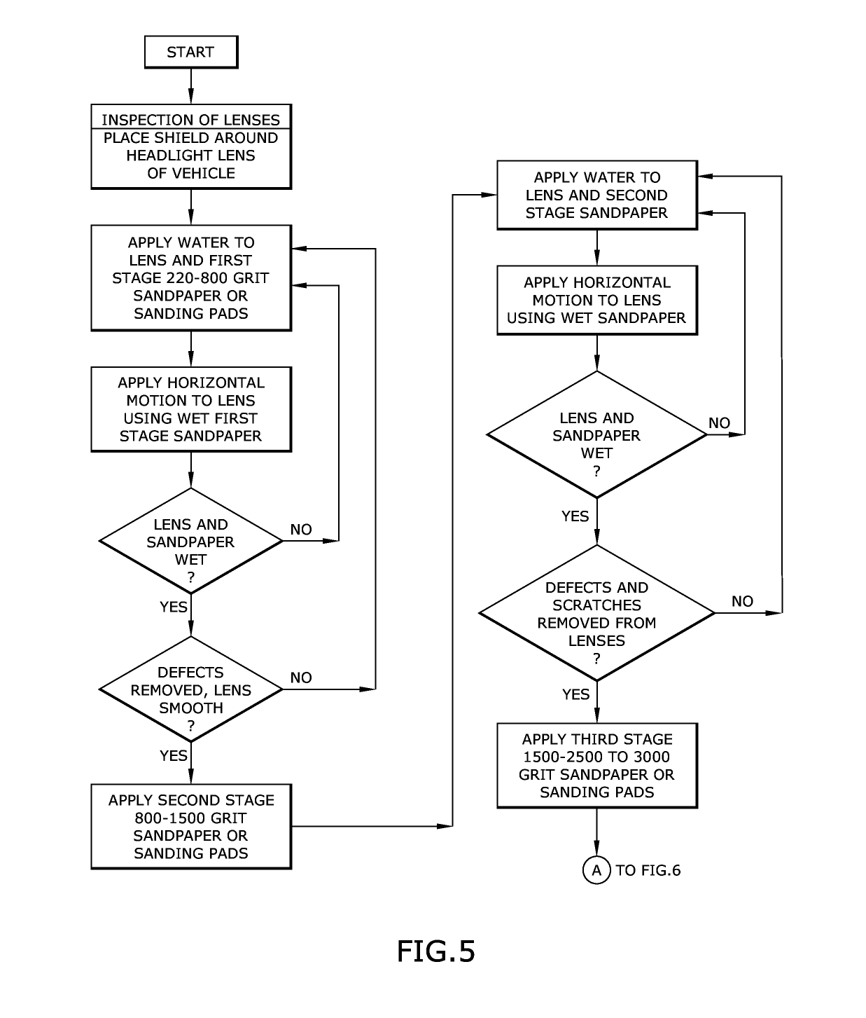

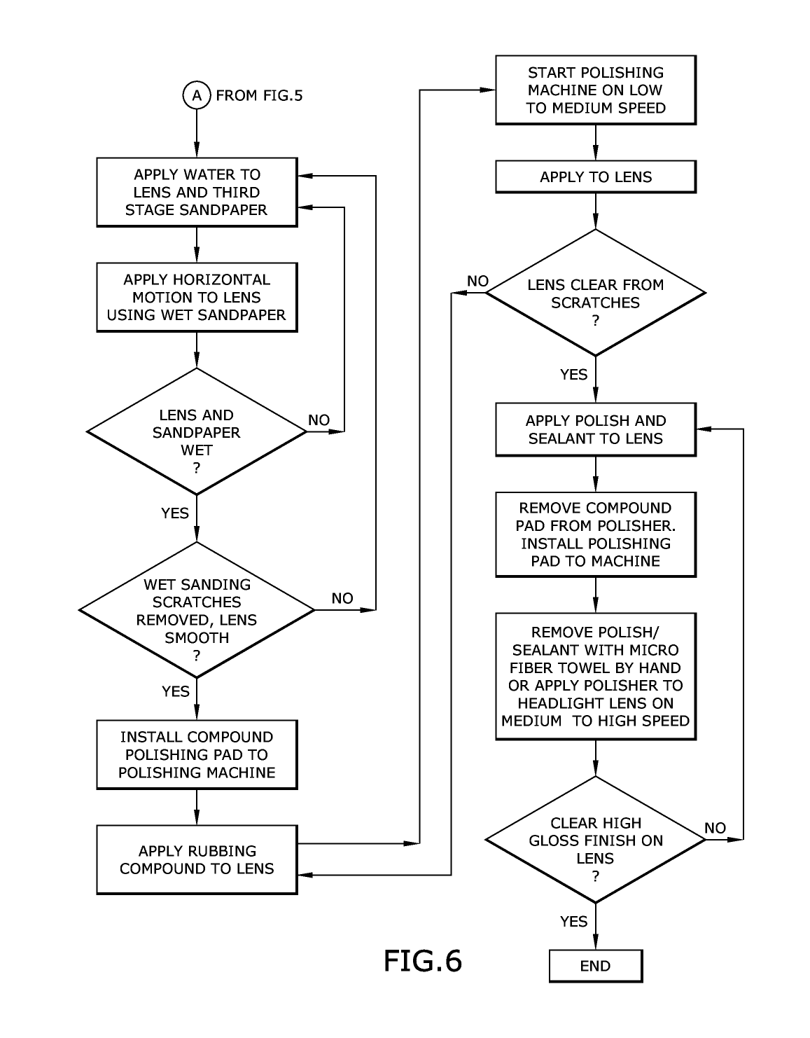

Referring to FIGS. 1 through 6, the present invention embodies a method for inexpensively cleaning plastic headlight lenses 10 of a vehicle 24, whereby transparency is restored along with driver safety and visibility. Specifically, the method removes oxidation and other indicia of opacity from the lens by a sequence of wet sanding applications, followed by an application of polish and sealant.

During operation of the vehicle 24, it is common for the headlight lenses 10 to take on dirt, debris, oxidation defects, scratches and roughness—indicia of opacity—so as to increase the opacity thereof. The headlight lens 10 is typically secured to the vehicle 24 and framed by a lens shield 12. The shield 12 may or may not be removed during the method of the present invention.

The method starts, in step 100, with a user inspecting the lens 10 to determine if insufficient transparency (or sufficient indicia of opacity) is present along the outer surface of the lens 10. Such an inspection may be made by sight, by touch or a combination thereof.

In step 110, the user applies water to the lens 10 so as to remove debris and dirt, and then provides a first stage coated abrasive 14 for the lens 10. The coated abrasive may include any sufficient form of heavy paper/pad with abrasive material attached to at least one surface, such as sandpaper or abrasive pad, wherein the abrasive material is measured in grit size. Grit size refers to the size of the particles of abrading materials embedded in the coated abrasive for removing at least one layer of indicia of opacity from the lens 10. The grit size may be reflected in the International Organization of Standards (IOS) standards. The first stage coated abrasive 14 may range from approximately 220 to 800 (IOS), or very fine to super fine grit size. In step 120, the user may apply the first stage coated abrasive 14 in horizontal motion to the lens 10 while the lens 10 is moist with the water, or in other words “wet sanding.” In step 130, if the first stage coated abrasive 14 becomes sufficiently dry of the water, then the user should reapply the water to the lens 10, returning to step 110.

In step 140, the user should determine if the oxidation defects amounting to indicia of opacity are sufficiently removed: if not, then user should repeat steps 110 through 130; but if the oxidation defects amounting to indicia of opacity are sufficiently removed, then user should proceed to step 150.

In step 150, the user may provide a second stage coated abrasive 16. The second stage coated abrasive 16 may include a grit size ranging between approximately 800 to approximately 1500 (IOS), or super fine to ultra fine grit size. In steps 160 and 170, the user may “wet sand” by applying the water and the second stage coated abrasive 16 to the lens 10. In step 180, if the second stage coated abrasive 16 becomes sufficiently dry of the water, then the user should reapply the water to the lens 10, returning to step 160.

In step 190, the user should determine if the oxidation defects and scratches amounting to indicia of opacity are sufficiently removed: if not, then user should repeat steps 160 through 180; but if the oxidation defects and scratches amounting to indicia of opacity are sufficiently removed, then user should proceed to step 200.

In step 200, the user may provide a third stage coated abrasive 18. The third stage coated abrasive 18 may include a grit size ranging between approximately 1500 to approximately 3500 (IOS), or varying degrees of ultra fine grit size. In steps 210 and 220, the user may “wet sand” by applying the water and the third stage coated abrasive 18 to the lens 10. In step 230, if the third stage coated abrasive 18 becomes sufficiently dry of the water, then the user should reapply the water to the lens 10, returning to step 210.

In step 240, the user should determine if the oxidation defects, scratches and roughness amounting to indicia of opacity are sufficiently removed: if not, then user should repeat steps 210 through 230; but if the oxidation defects, scratches and roughness amounting to indicia of opacity, then user should proceed to step 250.

In step 250, the user may install a compound polishing pad or equivalent to a polishing machine. In step 260, the user may apply a rubbing compound or equivalent to the lens 10. In step 270, the user may start the polishing machine on low to medium speed, applying the rubbing compound to the lens in step 280.

In step 290, the user should determine if the scratches amounting to indicia of opacity are sufficiently removed: if not, then user should repeat steps 260 through 280; but if the scratches amounting to indicia of opacity are sufficiently removed, then user should proceed to step 300.

In step 300, the user may apply a polish 20 and a sealant 26 to the lens 10. Then the user may remove the compound polishing pad from the polisher machine, and replace with a polishing pad, in step 310. In step 320, the user may remove the polish 20 and the sealant 26 by applying the polishing pad to the lens 10 on a medium to high speed of the polishing machine. In an alternative embodiment, the user may provide a microfiber or equivalent towel to manually remove the polish 20 and the sealant 26.

In step 330, the user should determine if the lens 10 has attained a high gloss finish 22: if not, then user should repeat steps 300 through 320; but if so, then the method is complete.

In certain embodiments, after the inspection of step 100, the user may determined that the first stage coated abrasive 14 need not be provided, and so the user may skip steps 110 through 140 and proceed directly to step 150, providing the second stage coated abrasive 16, and continuing from there.

It should be understood, of course, that the foregoing relates to exemplary embodiments of the invention and that modifications may be made without departing from the spirit and scope of the invention as set forth in the following claims.

What is claimed is:

1. A method of increasing the transparency of plastic lens by removing the indicia of opacity, comprising:
applying water to the plastic lens;
providing a second stage coated abrasive;
wet sanding the second stage coated abrasive to the water-applied plastic lens until oxidation defects and scratches amounting to indicia of opacity are removed;
reapplying the water to the plastic lens;
providing a third stage coated abrasive; and
wet sanding the third stage coated abrasive to the water-reapplied plastic lens until oxidation defects, scratches and roughness amounting to indicia of opacity are removed.

2. The method of claim 1, wherein the wet sanding is performed with a horizontal motion across the plastic lens.

3. The method of claim 1, wherein the second stage coated abrasive comprises a grit size ranging from approximately 800 to 1500.

4. The method of claim 1, wherein the third stage coated abrasive comprises a grit size ranging from approximately 1500 to 3500.

5. The method of claim 1, further comprising providing a first stage coated and wet sanding the first stage coated abrasive to the water-applied plastic lens until oxidation defects amounting to indicia of opacity are removed.

6. The method of claim 1, wherein the first stage coated abrasive comprises a grit size ranging from approximately 220 to 800.

7. The method of claim 6, further providing an initial inspection of the plastic lens to determine if the first stage coated abrasive is necessary.

8. The method of claim 1, further providing a polish and a sealant.

9. The method of claim 8, wherein the polish and the sealant are applied to the plastic lens by a polishing machine at a low to medium speed.

10. A method of increasing the transparency of plastic lens by removing the indicia of opacity, comprising:
applying water to the plastic lens;
providing a first stage coated abrasive, wherein the first stage coated abrasive comprises a grit size ranging from approximately 220 to 800;
wet sanding the first stage coated abrasive to the water-applied plastic lens until oxidation defects amounting to indicia of opacity are removed;
reapplying water to the plastic lens;
providing a second stage coated abrasive, wherein the second stage coated abrasive comprises a grit size ranging from approximately 800 to 1500;
wet sanding the second stage coated abrasive to the water-reapplied plastic lens until oxidation defects and scratches amounting to indicia of opacity are removed;
reapplying water to the plastic lens;
providing a third stage coated abrasive, wherein the third stage coated abrasive comprises a grit size ranging from approximately 1500 to 3500; and
wet sanding the third stage coated abrasive to the water-reapplied plastic lens until oxidation defects, scratches and roughness amounting to indicia of opacity are removed,
wherein wet sanding is performed with a horizontal motion across the plastic lens.
